(19) United States
(12) Patent Application Publication
(10) Pub. No.: US 2005/0171292 A1
(43) Pub. Date: Aug. 4, 2005

(54) Polymers and composition for in-mold decoration

(76) Inventors: HongMei Zang, Sunnyvale, CA (US); Fei Wang, Newark, CA (US); Haiyan Gu, Fremont, CA (US); Rong-Chang Liang, Cupertino, CA (US)

Correspondence Address: HOWROY SIMON ARNOLD & WHITE, LLP, c/o IP DOCKETING DEPARTMENT, 2941 FAIRVIEW PARK DRIVE, SUITE 200, FALLS CHURCH, VA, 22042-2924, US

(21) Appl. No.: 11/051,444

(22) Filed: Feb. 3, 2005

Related U.S. Application Data
(60) Provisional application No. 60/541,797, filed on Feb. 4, 2004.

(51) Int. Cl. C08F 14/18

(52) U.S. Cl. 525/330.3; 526/319; 526/344; 526/255; 526/346

(57) ABSTRACT

This invention relates to polymers or copolymers and a composition suitable for the formation of a durable layer in an in-mold decoration process.

### RELATED APPLICATIONS

This application claims the priority under 35 USC 119(e) of U.S. Provisional Application No. 60/541,797 filed on Feb. 4, 2004. The whole content of the priority application is incorporated herein by reference in its entirety.

### BACKGROUND OF THE INVENTION

This invention relates to polymers or copolymers and a composition suitable for the formation of a durable layer in an in-mold decoration process.

In-mold decoration processes involve decorating articles as they are formed, in mold, of a heated plastic material being injected into a mold cavity. Usually a tape or strip of a decorating or protective material is automatically or manually advanced, pre-fed and positioned in the mold cavity at each molding cycle, interfacing therein with the plastic material as it is filled into the mold cavity, under heat and pressure. As the article is formed, the decorating material forms on the surface of the article and becomes an integral and permanent part of the article, through thermal transfer in the in-mold decoration process. Other molding processes such as thermal forming, blow molding and compression molding or stamping may also be used for the transfer of a decorating or protective material. Sometimes the process may also be called in-mold labeling or in-mold coating, and the transferable protective material may be called a thermal transfer overcoat or durable coat layer.

The decoration tape or strip usually comprises a carrier layer, a release layer, a durable layer, an adhesive or tie-coat layer and also a layer of decorative designs (metal or ink). After the injection molding transfer, the carrier layer and the release layer are removed, leaving the durable layer as the outmost layer. The durable layer therefore is an essential part of the decorative tape or strip as it serves as a protective layer with scratch resistance, mar or abrasion resistance and solvent resistance to protect the decorative designs and also the molded article.

An effective durable layer must meet certain criteria. For example, it needs to be a non-tacky or non-blocking coating to allow roll-up and also to be able to tolerate subsequent image forming conditions. Secondly it needs to be conformable during the injection molding process to adapt to the 3D shape of the molded article. In addition, an effective durable layer needs to be able to withstand a high shear force and high temperature polymer melt in the injection molding process and maintain a shinny metallic pattern if it exists. Furthermore, it needs to have excellent hardness and solvent and abrasion resistance to protect the decorative image during usage.

Traditional UV curable compositions are not suitable as a hard coat or durable layer in in-mold decoration processes. Most of commonly used protective durable layer compositions comprise multifunctional acrylate/methacrylate monomers, and/or acrylate/methacrylate oligomers and optionally binders. If such a durable layer is fully crosslinked before injection molding, the durable layer is not conformable for injection molding with a high step height difference or a sharp edge. In this case, cracks or a rough surface will show up at the steps. In addition, in order to achieve acceptable hardness (≧2 H for many applications), a high content of the monomers and oligomers is desirable. However, if the durable layer is not crosslinked before injection molding, the high content of monomers and oligomers may significantly lower the Tg of the composition before curing. In this case, deformation under the higher temperature and shear during injection molding process will create stripes and other defects on the durable layer. If a thin metal or ink pattern exists on the soft durable layer, deformation or distortion of the pattern may occur. Partial curing of such a durable layer before injection molding could solve these problems. However, the process window is in general quite narrow and the manufacturing reproducibility is difficult to achieve. Moreover, low molecular weight multifunctional acrylate or methacrylate monomers have a tendency to migrate to neighboring layers (e.g., the release layer, the decorative layer or the adhesive layer) during storage or injection molding process. The migration of the monomers causes deterioration of not only the UV crosslinking property in the hard coat or durable layer but also the properties of neighboring layers of the in-mold decoration foil.

U.S. Pat. No. 5,993,588 discloses a protecting layer formed from a heat and radiation curable resin composition which comprises a polyfunctional isocyanate and a polymer having a (meth)acryl equivalent weight from 100 to 300 g/eq., a hydroxyl value from 20 to 500 and a weight average molecular weight from 5,000 to 50,000. The method however has some major disadvantages. First of all, polyurethane thermal curing is sensitive to moisture. Trace amount of water in the composition or the coating environment will consume a significant amount of the isocyanate functionality and result in poor reproducibility of the crosslinking reaction and coating defects due to the reaction product CO₂, particularly in the presence of certain catalysts, for example, the tin catalysts. Therefore, strict control of the humidity level during coating and drying of the composition is required. In addition, in order to achieve a metallic decorative layer of high gloss, the partially thermal-cured durable layer preferably has a high heat distortion temperature and yet still has (1) high photoreactivity for the UV post curing at a high speed to achieve acceptable scratch resistance, solvent resistance and hardness, and (2) high flexibility for 3D contour molding. Unfortunately these requirements tend to be in conflict and as a result, the durable layer composition often has a narrow process window for optimum metal deposition and the molding/post curing processes. The durable/protective layer and the in-mold decoration foil resulted from the method of U.S. Pat. No. 5,993,588 tend to be brittle and show defects such as cracking and dust particles during handling and conversion. Furthermore, the thermal partial curing of the durable layer composition in a production coater tends to be difficult to control. The high speed crosslinking required for low cost production often results in a short storage stability or green time of the coating fluid.

It is highly desirable that a high rate of crosslinking in the coater is achieved by a wider coating process window with a more stable composition.

### SUMMARY OF THE INVENTION

The first aspect of the invention is directed to a group of polymers or copolymers suitable to be used for formation of a durable layer in in-mold decoration processes. The polymers or copolymers comprise at least one carboxylic acid or acid anhydride functionality for thermal crosslinking and at least one UV crosslinkable functionality. The UV crosslinkable functionality may be an acrylate, methacrylate, vinyl ether, epoxy or a combination thereof, with acrylate, methacrylate or vinyl ether as the preferred.

The equivalent weight of the acid functionality is preferably less than about 3,000 g/eq., more preferably less than about 1000 g/eq. The equivalent weight of the UV cross linkable functionality is also preferably less than about 3,000 g/eq., more preferably less than about 1000 g/eq.

The molecular weight of the polymers or copolymers is in the range of about 1000 to about 500,000, preferably in the range of about 3000 to about 100,000.

The second aspect of the invention is directed to a durable layer composition comprising (1) a polymer or copolymer of the first aspect of the invention and (2) a thermal crosslinker. The thermal curing of the acid or acid anhydride functionality of the polymer or copolymer may take place before, during or after coating of the composition, but before injection molding. The curing of the UV crosslinkable functionality to form a durable layer takes place after injection of the plastic material. The UV curing step is essential in achieving desired hardness and scratch resistance. Because there are no low molecular weight monomers or oligomers present in the composition after thermal crosslinking, there is no material migration during storage or the injection molding process.

The durable layer composition may further optionally comprise fillers, surfactants, bactericides or fungicides, photoinitiators or photosensitizers, oxygen scavengers or autooxidizers, UV absorbers or light stabilizers, antioxidants, radiation, particularly UV curable oligomers or polymers, lubricants or colorants.

The third aspect of the invention is directed to an in-mold decoration process for the manufacture of an article having a durable layer of the present invention.

The fourth aspect of the present invention is directed to a plastic article having a durable layer of the present invention on its top surface.

The fifth aspect of the present invention is direct to a plastic article comprising a durable layer of the present invention and a decorative metallic layer and/or an ink layer.

The present invention achieves the purpose of providing a durable layer for in-mold decoration which has excellent surface quality with a wider geometric tolerance, at low cost.

### BRIEF DESCRIPTION OF THE DRAWINGS

FIG. 1 is a cross section view of an in-mold decoration tape or strip.

FIG. 2 shows how the in-mold decoration tape or strip is fed into a mold cavity.

### DETAILED DESCRIPTION OF THE INVENTION

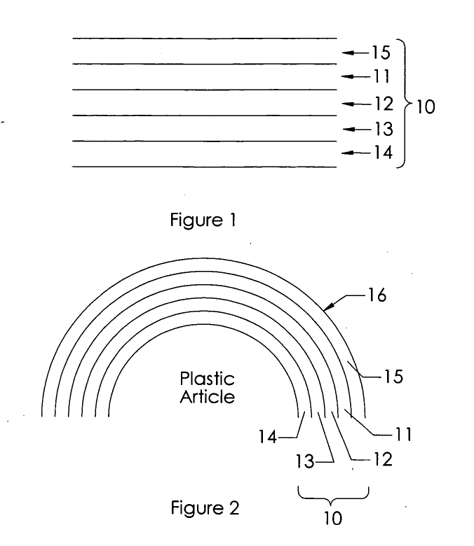

FIG. 1 is a cross-section view of an in-mold decoration tape or strip (10) which comprises a carrier layer (15), a release layer (11), a durable layer (12), a decorative design layer (13), and an adhesive layer (14).

In an in-mold decoration process, the tape or strip (10) is fed into a mold cavity (16) automatically or manually with the carrier layer (15) in contact with the mold surface as shown in FIG. 2. The tape or strip may be thermally formed to a desirable shape before the feeding step.

The carrier (15), release (11) and adhesive (14) layers may be formed by methods known in the art and all of the previously known carrier, release and adhesive layers may be incorporated into the present invention.

For example, the carrier layer (15) usually is a thin plastic film with a thickness from about 3.5 to about 100 microns, preferably about 10 to about 50 microns.

Polyethylene terephthalate (PET), polyethylene naphthate (PEN) or polycarbonate (PC) films are particularly preferred because of their low cost, high transparency and thermomechanical stability.

The release layer (11) allows the in-mold decoration tape or strip to be released from the carrier layer in a manner that minimizes damage to the durable layer (12) and the decorative layer (13) and also enables a fully automated roll transfer process during molding. The release layer usually is a low surface tension coating prepared from a material such as wax, paraffin or silicone or a highly smooth and impermeable coating prepared from a material selected from the group consisting of melamine formaldehyde, metal thin film such as Al or Sn, crosslinked polyacrylates, silicone acrylates, epoxides, vinyl esters, vinyl ethers, allyls and vinyls, unsaturated polyesters or blends thereof. The release layer may comprise a condensation polymer, copolymer, blend or composite selected from the group consisting of epoxy, polyurethane, polyimide, polyamide, melamine formaldehyde, urea formaldehyde, phenol formaldehyde and the like.

The adhesive layer (14) is incorporated into the in-mold decoration tape or strip to provide optimum adhesion of the decorative layer to the top surface of the molded article. The adhesive layer may be formed from a material such as polyacrylate, polymethacrylate, polystyrene, polycarbonate, polyurethane, polyester, polyamide, epoxy resin, ethylene vinylacetate copolymers (EVA), thermoplastic elastomers or the like, or a copolymer, blend or composite thereof. Hot melt or heat activated adhesives such as polyurethane and polyamide are particularly preferred. The thickness of the adhesive layer may be in the range of about 1 to about 20 microns, preferably in the range of about 2 to about 6 microns.

The decorative layer (13) may be a metallic layer or an ink layer formed from a method such as vapor deposition or sputtering optionally followed by a patterning process. The ink pattern may be formed by a printing process such as gravure, flexo, screen, sublimation heat transfer or the like, on a substrate layer. Optionally, a tie layer may be used to enhance the adhesion between the durable layer and the decoration layer. The substrate layer may be a plastic layer or an insulator-coated metal or metal oxide foil formed from carbon steel, stainless steel, Al, Sn, Ni, Cu, Zn, Mg or an alloy or oxide thereof.

The decorative designs may also be pre-shaped by thermoforming. In this case, the carrier layer (15) becomes part of the molded article. The decorative layer having raised or recessed patterns is typically in the range of about 0.2 to about 1 mm, preferably in the range of about 0.3 to about 0.7 mm, in thickness. It is usually thermoformed from an ABS (acrylonitril-butadiene-styrene), polycarbonate, acrylics, polystyrene or PVC sheet in a mold.

Alternatively, the decorative layer may be also pre-shaped by high pressure forming involving the use of high-pressure air to create decorative designs on a film. The decorative layer may also be formed by hydroforming in which a hydrostatic bladder, rather than air, serves as the forming mechanism.

The first aspect of the present invention relates to a group of polymers or copolymers which may be incorporated into a composition suitable for the formation of the durable layer (12).

The polymers or copolymers comprise at least one carboxylic acid or acid anhydride functionality for thermal crosslinking and at least one UV crosslinkable functionality. The UV crosslinkable functionality may be an acrylate, methacrylate, vinyl ether, epoxide or a combination thereof, with acrylate, methacrylate or vinyl ether as the most preferred.

The equivalent weight of the acid or acid anhydride functionality is preferably less than about 3,000 g/eq., more preferably less than about 1000 g/eq. The equivalent weight of the UV cross linkable functionality is also preferably less than about 3,000 g/eg, more preferably less than about 1000 g/eq. The term “equivalent weight” is defined as the molecular weight of the polymer divided by the number of the functionality.

The molecular weight of the polymers or copolymers is in the range of about 1000 to about 500,000, preferably in the range of about 3000 to about 100,000.

The backbone (i.e., the “main chain”) of the polymer or copolymer can be of any polymeric structure. For example, it may be a homopolymer, a random, block or graft copolymer. More specifically, it may be derived from a polyacrylate, polymethacrylate, polyolefin, polystyrene, poly(vinyl chloride), poly(vinylidene chloride), polyvinyl alcohol, polyester, polyurethane, polyamide, polyether, cellulose, copolymer of maleic or phthalic anhydride or the like. Preferably the backbone polymer has a high glass transition temperature (Tg) or heat distortion temperature (HDT) and high modules at the application conditions (temperature, pressure, shear rate etc.).

Both the acid or acid anhydride functionality and the UV crosslinkable functionality are preferably on the side chains. The UV crosslinkable functionality is preferably at least three atoms, more preferably five atoms, away from the main chain (i.e., the backbone) of the polymer or copolymer to decouple the local mobility from the main chain and facilitate an efficient UV curing. The linking moiety (of preferably at least three atoms) between the UV crosslinkable functionality and the main chain may comprise atoms such as carbon, oxygen, sulfur, nitrogen or other heteroatoms. For example, the linking moiety may be a linear or branched carbon chain comprising an ether, thio, ester or amide group.

The Tg or HDT of the polymer or copolymer of the present invention is preferably higher than 0° C., more preferably higher than 20° C. and most preferably higher than 40° C.

To achieve a better conformation flow for a 3D object of sharp step height or relief image, a low melt flow temperature or a low melt flow viscosity is highly desirable. The melt flow temperature of the polymer or copolymer of the present invention is preferably lower than 180° C., and more preferably lower than 140° C. in order for the thermally crosslinked polymer to be conformable during injection molding. However, a polymer having a high Tg or HDT that meets the requirements of non-tacky and/or minimum dusting temperature, also tends to exhibit a high melt flow temperature (MFT) or high melt flow viscosity. Thus a polymer having a small difference in MFT and Tg is highly desirable to meet both the conformation and processing requirements. It is found that polymers having a phenyl substituent or a highly branched side chain appear to have a small difference (MFT-Tg) and therefore are more preferred in the present invention.

The polymer or copolymer can be synthesized by polymerization or copoymerization of acid functionalized monomers, for example, maleic anhydride, acrylic acid, methacrylic acid, itaconic acid for radical polymerization, carboxylated diol for condensation reaction, followed by partial modification of the acid on the side chains to an acrylate moiety by reacting with, for example, hydroxy alkyl acrylate. Commercially available polymers with reactive groups on the side chains can be modified to the desirable structures. For example, carboxylic acid functionalized Joncryl polymer, which is a copolymer of acrylic acid, methyl methacrylate and styrene, can be modified by partially reacting it with glycidyl acrylate or glycidyl methacrylate. Homopolymer or copolymer of maleic anhydride can be modified by reacting it with a hydroxy alkyl acrylate. Ring opening of the maleic anhydride group may afford a carboxylic acid functionality and an ester functionality with acrylate on the same side chain. Different reaction conditions can affect the ratio of acid and ester functionalities.

The second aspect of the invention is directed to a durable layer composition which comprises (1) a polymer or copolymer of the first aspect of the invention and (2) a thermal crosslinker. The thermal curing of the acid or acid anhydride functionality of the polymer or copolymer takes place before, during or after coating of the composition, but before injection of the plastic material. In the thermal cure step, the acid or acid anhydride functionality is thermally crosslinked by the second component in the composition, i.e., a thermal crosslinker. Suitable thermal crosslinkers may include, but are not limited to, polyaziridine, polycarbodiimide, polyepoxide or a combination thereof. The molar ratio between the thermal crosslinker and the acid or acid anhydride functionality is in the range of about 0.8 to about 1.2, preferably greater than 1. A slight excess amount of the thermal crosslinker is useful when the durable layer is in direct contact with a metal layer because the acid may cause rusting of the metal layer and reduce the gloss. Excess amount of carbodiimide or aziridine is also useful to suppress the rusting of the metal layer due to polymer decomposition during usage. The combination of a polyaziridine and a polyepoxide has a synergetic effect for thermal curing. In this case, the reaction between polyaziridine and the acid functionality generates an amine, which will react rapidly with the polyepoxide to complete the thermal cure.

The polymer coating after thermal curing should have appropriate heat resistance for the subsequent metallization process. The heat resistance may be characterized by the minimum dusting temperature of a film. The minimum dusting temperature is defined as the lowest temperature at which the dust starts to stick on the film and it is measured after thermal curing on the film in free-standing form, without applied pressure. The minimum dusting temperature should not be lower than the web surface temperature during metal vapor deposition under an acceptable winding/unwinding pressure in order to achieve a shiny metal surface finish. In the present invention, the minimum dusting temperature is preferably higher than 40° C., more preferably higher than 60° C.

The radiation curing of the crosslinkable functionality to form a durable layer takes place after injection of the plastic material. This step is essential in achieving desired hardness and scratch resistance.

In addition to the main components, the composition may further comprise additives such as fillers, surfactants, bactericides or fungicides, photoinitiators or photosensitizers, oxygen scavengers or autooxidizers, UV absorbers or light stabilizers, antioxidants, radiation or UV curable oligomers or polymers, lubricants or colorants.

The fillers may include, but are not limited to, silica, CaCO₃, microgel particles or mica. If present, the concentration range of the filler may be about 0.1% to about 30% by weight of the total composition.

The surfactants may include, but are not limited to, Silwet surfactants (from GE silicones-Osi Specialties, NY) or triton surfactants (from Dow Chemical, CT). If present, the concentration range of the surfactant may be about 0.1% to about 5% by weight of the total composition.

The photoinitiators or photosensitizers may include, but are not limited to, Norrish Type 1, Type 2 and Type 3 photoinitiators such as ITX (isopropyl thioxanthone), Irgacure 651 (2,2-dimethoxyl,2-diphenylethane), 907 (2-methyl-1-[4-(methylthio)phenyl]-2-morpholino-1-propanone), 369 (2-benzyl-2-(dimethylamino)-1-[4-(4-morpholinyl)phenyl]-1-butanone) or 184 (1-hydroxycyclohexylphenylketone) from Ciba Specialty Chemicals. The amount of the photoinitiator or photosensitizer is usually in the range of about 0.5% to about 5% by weight of the total composition.

The bactericides or fungicides may include, but are not limited to, Omacide (from Arch Chemical) or Fungitrol (from ISP). If present, the concentration range of the bactericide or fungicide may be about 0.1% to about 5% by weight of the total composition.

The oxygen scavengers or autooxidizers may include, but are not limited to, triethylamine, triethanolamine, N-methyl diethanolamine, alkyl N,N-dimethylaminobenzoate or 2,6-diisopropyl-N,N-dimethylaniline. If present, the concentration range of the oxygen scavenger may be about 1% to about 5% by weight of the total composition.

The UV absorbers may include, but are not limited to, triazine or benzotriazole derivatives. If present, the concentration range of the UV absorber may be about 0.5% to about 4% by weight of the total composition.

The light stabilizers may include, but are not limited to, hindered amine light stabilizers. If present, the concentration range of the light stabilizer may be about 0.1% to about 3% by weight of the total composition.

The antioxidants may include, but are not limited to, BHT (butylated hydroxytoluene), MEHQ (hydroquinone monomethylether) or tetrakis[methylene-3(3′,5′-di-tert-butyl-4-hydroxyphenyl)propionate]methane. If present, the concentration range of the antioxidant may be about 0.01% to about 1% by weight of the total composition.

The UV curable oligomers or polymers may include, but are not limited to, acrylate oligomers, such as urethane acrylates or epoxy acrylates or high molecular weight multifunctional acrylate monomers. If present, the concentration of the added oligomers or monomers may be in the range of about 5 to about 50%, preferably about 3 to about 20%, by weight of the total composition. In this aspect, acid functionalized acrylate monomers and oligomers such as β-CEA (β-carboxyethyl acrylate acrylic oligomer, from UCB) are especially useful.

Lubricants may include, but are not limited to, silicon acrylates, zinc stearate or microcrystalline wax. If present, the concentration range of the lubricant may be about 0.5% to about 5% by weight of the total composition.

The polymer or copolymer of the present invention along with a thermal crosslinker and the other optional additive(s) are dispersed or dissolved in a suitable solvent, such as ketones, esters, ethers, glycol ethers, glycolether esters, pyrrolidones, with ketones and esters such as methyl ethyl ketone, (MEK), methyl propyl ketone (MPK), cyclohexanone, ethyl acetate, propyl acetate and butyl acetate as the preferred. The solid content of the composition is preferably in the range of about 3 to about 90%, preferably about 10% to about 50%, by weight.

Because there are no low molecular weight monomers present in the composition after thermal crosslinking, material migration during storage or the injection molding process is not an issue.

In the formation of the in-mold decorative tape or strip (10), the release layer (11), the durable layer (12), the decorative design layer (13) and the adhesive layer (14) are sequentially coated or laminated onto the carrier layer (15). The lamination or coating may be accomplished by coating methods such as slot coating, doctor blade coating, gravure coating, roll coating, comma coating, lip coating and the like or printing methods such as gravure printing, screen printing and the like. The decorative tape or strip may further comprise a tie layer between the durable layer and the decorative layer.

After the decorative tape or strip is formed, the thermal cure is performed during the drying of the durable layer coating step, optionally with a post cure step after the coating. The thermal cure can be carried out at about 50° C. to about 120° C. for various lengths of time, for example, several minutes to hours, depending on the curing conditions and the composition. The UV cure is performed after the injection molding process when the protective layer has been transferred to the surface of the molded article. The molded articles are placed on a UV conveyor that is running at, for example, 0.6 ft/min to 10 ft/min. The UV curing energy needed is usually in the range of from about 0.1 to about 5 J/cm², preferably about 0.3 to about 1.2 J/cm².

The durable layer of the present invention is suitable for all in-mold decoration processes for the manufacture of a plastic article. Examples of the material suitable for the article may include, but are not limited to, thermoplastic materials such as polystyrene, polyvinyl chloride, acrylics, polysulfone, polyarylester, polypropylene oxide, polyolefins, acrylonitrile-butadiene-styrene copolymers (ABS), methacrylate-acrylonitrile-butadiene-styrene copolymers (MABS), polycarbonate, polybutylene terephthalate (PBT), polyethylene terephthalate (PET), polyurethanes and other thermoplastic elastomers or blends thereof, and thermoset materials such as reaction injection molding grade polyurethanes, epoxy resin, unsaturated polyesters, vinylesters or composites, prepregs and blends thereof.

The article may be a plastic cover of a cell phone or pager. In fact, the durable layer is useful for any plastic articles manufactured from an in-mold decoration process, such as personal accessories, toys or educational devices, plastic cover of a personal digital assistant or e-book, credit or smart cards, identification or business cards, face of an album, watch, clock, radio or camera, dashboard in an automobile, household items, laptop computer housings and carrying cases or front control panels of any consumer electronic equipments. This is clearly not exhaustive. Other suitable plastic articles would be clear to a person skilled in the art and therefore they are all encompassed within the scope of the present invention. The durable layer of the present invention is also useful in applications such as the thermal transfer protective coating for thermal printing, inkjet printing and passport and other identification applications.

The present invention has achieved the purpose of providing a durable layer or protective coating for in-mold decoration which has excellent surface quality with a wider geometric tolerance, at low cost.

### EXAMPLES

The following examples are given to enable those skilled in the art to more clearly understand, and to practice, the present invention. They should not be considered as limiting the scope of the invention, but merely as being illustrative and representative thereof.

### Preparation 1

### Preparation of Release Layer for In-Mold Decoration

15.0 Gm of CYMEL 303ULF (hexamethoxymethylmelamine from Cytec Industries Inc., West Paterson, N.J.) and 105 gm of MEK were mixed at 600 rpm for 5 minutes. 0.3 Gm of CYCAT600 (a proprietary catalyst from Cytec Industries Inc., West Paterson, N.J.) was added and stirred at 600 rpm for additional 5 minutes. The resultant solution was then filtered with a 0.2 um filter and coated onto a 1.42 mil PET (SH22, from SKC, South Korea) with a #4 Meyer bar for a targeted thickness of 1 um. The coated film was then air dried for 5 minutes and baked in an oven at 130° C. for 10 minutes.

### Example 1

### Preparation of the Polymer by Modification of Joncryl Polymer with GMA

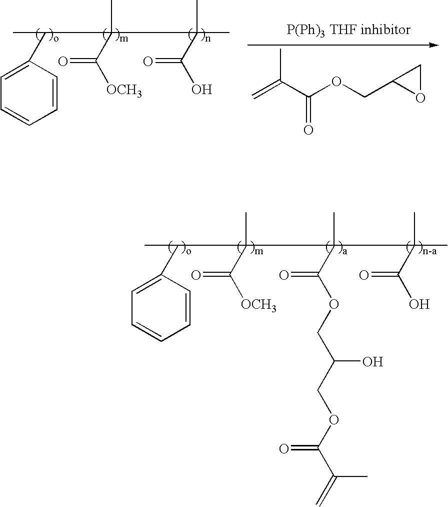

5.0 Gm of JONCRYL 587 (polystyrene-co-polymethylmethacrylate-co-polyacrylic acid, acid number 214, from Johnson Polymer) was dissolved in 10 gm of ethyl glyme (from Aldrich). While stirring, 2.18 gm of GMA (glycol methacrylate from Aldrich), 0.08 gm of triphenylphosphine and 0.05 gm of BHT (2,6-di-tert-butyl-4-methylphenol, from Aldrich) were added. The mixture was stirred for 8 hours at 110° C. and then a polymer product (JP-GMA) was precipitated in 400 ml of a 1:1 methanol/water solution and vacuum dried in oven overnight till its weight became constant. The acid functionality in the polymer was determined by acid titration (ASTM D974-02). The acid number was 80. The term “acid number” is the number of milligrams of KOH neutralized by the free acid present in one gram of the substance.

### Example 2

### Preparation of the Polymer by Modification of Joncryl Polymer with HBA

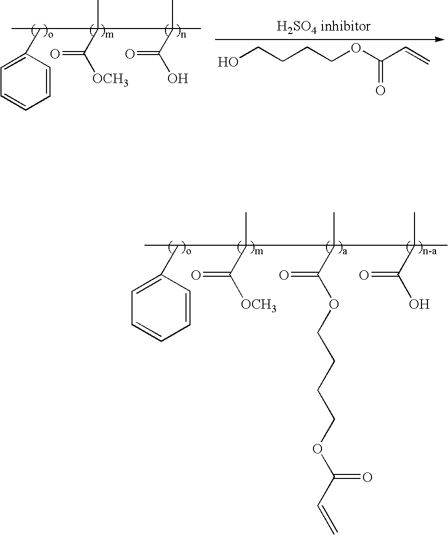

5.0 Gm of JONCRYL 587 (polystyrene-co-polymethylmethacrylate-co-polyacrylic acid, acid number 214, from Johnson Polymer) was dissolved in 20 ml of THF. While stirring, 2.2 gm of HBA (hydroxybutyl acrylate, from Aldrich), 0.5 gm of concentrated sulfuric acid and 0.02 gm of BHT (from Aldrich) were added. The solution was refluxed for 18 hours and then a polymer product (JP-HBA) was precipitated in 500 ml of a 1:1 methanol/water solution and dried in oven overnight till its weight became constant. The acid functionality in the polymer was determined by acid titration (ASTM D974-02). The acid number was 93.

### Example 3

0.3 Gm of JP-GMA prepared from Example 1, 0.07 gm of EPON 825 (bisphenol A diglycidyl ether, from Noveon Inc.) and 0.015 gm of Irgacure 184 (1-hydroxycyclohexylphenylketone from Ciba Specialty Chemcials) were dissolved in a mixture of 0.38 gm of MEK and 0.1 gm of ethyl glyme and then 0.12 gm of XAMA-7 (polyaziridine, from Noveon Inc.) (50% solution in MEK) was thoroughly mixed with the resulting solution. The durable layer composition formed was coated on the release film prepared from Preparation 1 with a #18 Meyer bar. The coated composite film was air dried and cured at 120° C. for 2 hours. An adhesive consisting of 1 part of Sancure 2710 (aliphatic polyurethane from Noveon,lnc., Cleveland, Ohio) and 3 parts of DI water was then overcoated onto the cured durable layer using a #16 Meyer bar with a target thickness of about 3 um. The resultant film was inserted into an injection mold. A mixture of PMMA (polymethylmethacrylate) and polycarbonate was injected into a mold cavity at 490° F. and 550° F., respectively, with the adhesive layer facing the plastic mixture. The durable layer and the adhesive layer were completely transferred to the molded plastic article after the release film was peeled off. The molded article was then post cured by UV exposure (3.4 J/cm²) using a Fusion conveyor curing system. The solvent resistance and abrasion resistance of the durable layer were evaluated and the results are summarized in Table 1.

Samples were tested for solvent resistance by the MEK drop test. Abrasion resistance was tested using Norman abrasion tester with a load of 175 gm and 50 cycles.

### Example 4

0.3 Gm of JP-GMA prepared from Example 1, 0.5 gm of MEK-ST (silica dispersion from Nissan Chemicals) and 0.015 gm of Irgacure 184 (from Ciba Specialty Chemcials) were dissolved in 0.1 gm of ethyl glyme and then 0.54 gm of V-04B (polycarbodiimide, from Nisshinbo Inductry, Inc.) was thoroughly mixed with the resulting solution. The procedure of Example 3 was followed. The test results are also summarized in Table 1.

### Example 5

0.3 Gm of JP-GMA prepared from Example 1, 0.2 gm of β-CEA (β-carboxyethyl acrylate acrylic oligomer, from UCB Chemicals), 0.015 gm of Irgacure 184 (from Ciba Specialty Chemcials) and 0.008 gm of Tinuvin 770 (bis(2,2,6,6-tetramethyl-4-piperidyl sebacate, from Ciba Specialty Chemcials) were dissolved in 0.5 gm of MEK and then 0.5 gm of XAMA-7 (polyaziridine, from Noveon Inc.) in MEK (50%) solution was thoroughly mixed with the resulting solution. The procedure of Example 3 was followed. The test results are also summarized in Table 1.

### Example 6

The composition and procedure of Example 3 were followed except that Irgacure 184 was replaced with a mixture of 0.5% ITX (isopropyl-9H-thioxanthen-9-one, from Aldrich), 1.5% Irgacure 369 (2-benzyl-2-(dimethylamino)-1-[4-(4-morpholinyl)phenyl]-1-butanone, from Ciba) and 1.5% EPD (ethyl p-dimethylaminobenzoate, from Aldrich). The test results are also summarized in Table 1.

### Example 7

0.3 Gm of JP-HBA prepared from Example 2, 0.6 gm of β-CEA (β-carboxyethyl acrylate, from UCB Chemicals), 0.045 gm of Irgacure 184 (from Ciba Specialty Chemcials) and 0.02 gm of Tinuvin 770 (from Ciba Specialty Chemcials) were dissolved in 0.1 gm of MEK and then 1.31 gm of XAMA-7 (from Noveon Inc.) in MEK solution (50%) was thoroughly mixed with the resulting solution. The procedure of Example 3 was followed. The test results are also summarized in Table 1.

### Example 8

### Comparative Example

0.3 Gm of JP-GMA prepared from Example 1 and 0.015 gm of Irgacure 184 were dissolved in a mixture of 0.5 gm of MEK and 0.2 gm of ethanol. The resulting solution was coated on 5 mil of a PET film and cured by UV exposure (3.4 J/cm²) using a Fusion conveyor curing system. The test results are also summarized in Table 1.

TABLE 1

| | Solvent | Scratch | Surface |
|---|---|---|---|
| | Resistance | Resistance | Hardness* |
| 3 | Excellent | Good | 2H |
| 4 | Excellent | Fair | H |
| 5 | Excellent | Good | 2H |
| 6 | Excellent | Excellent | 2H |
| 7 | Excellent | Good | >2H |
| 8 | Excellent | Poor | HB |
| (comparative) | | | |

*Hardness was measured on a PET film.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, materials, compositions, processes, process step or steps, to the objective, spirit and scope of the present invention. All such modifications are intended to be within the scope of the claims appended hereto.

1. A polymer or copolymer useful for the formation of a durable layer in an in-mold decoration process, which polymer or copolymer comprises at least one carboxylic acid or acid anhydride functionality for thermal crosslinking and at least one UV crosslinkable functionality.

2. The polymer or copolymer of claim 1 wherein the UV crosslinkable functionality is an acrylate, methacrylate, vinyl ether, epoxide or a combination thereof.

3. The polymer or copolymer of claim 1 wherein the acid or acid anhydride functionality has an equivalent weight of less than about 3,000 g/eq.

4. The polymer or copolymer of claim 1 wherein the UV cross linkable functionality has an equivalent weight of less than about 3,000 g/eg.

5. The polymer or copolymer of claim 1 which has a molecular weight in the range of about 1000 to about 500,000.

6. The polymer or copolymer of claim 1 which comprises a backbone selected from the group consisting of polyacrylate, polymethacrylate, polyolefin, polystyrene, poly(vinyl chloride), poly(vinylidene chloride), polyvinyl alcohol, polyester, polyurethane, polyamide, polyether, cellulose and copolymer of maleic or phthalic anhydride.

7. The polymer or copolymer of claim 1 which has a glass transition temperature (Tg) or heat distortion temperature (HDT) higher than 0° C.

8. The polymer or copolymer of claim 1 which has a melt flow temperature lower than 180° C.

9. The polymer or copolymer of claim 1 which comprises a phenyl substituent on the main chain.

10. The polymer or copolymer of claim 1 which comprises a highly branched side chain.

11. The polymer or copolymer of claim 1 which may be expressed as follows: 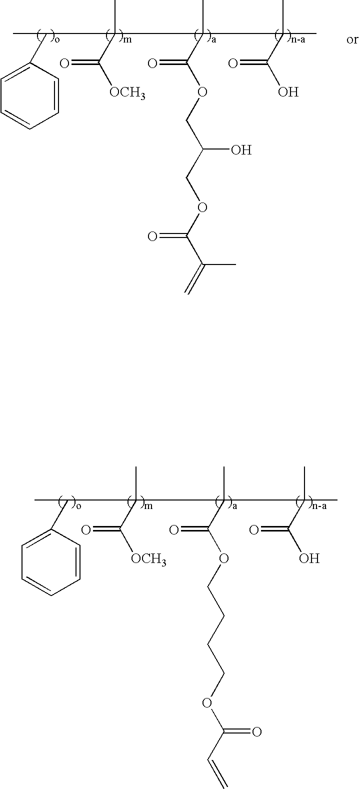
wherein o, m, a, n-a are the weight ratio of each repeating units;
o+m+n=1;
o is in the range of 10%-80%;
m is in the range of 5%-50%;
a is in the range of 5%-50%; and
n is in the range of 5%-80%.

12. A composition useful for the formation of a durable layer in an in-mold decoration process, which composition comprises:
(a) a polymer or copolymer comprising at least one carboxylic acid or acid anhydride functionality for thermal crosslinking and at least one UV crosslinkable functionality; and
(b) a thermal crosslinker.

13. The composition of claim 12 wherein the UV crosslinkable functionality is an acrylate, methacrylate, vinyl ether, epoxide or a combination thereof.

14. The composition of claim 12 wherein the acid or acid anhydride functionality has an equivalent weight of less than about 3,000 g/eq.

15. The composition of claim 12 wherein the UV cross linkable functionality has an equivalent weight of less than about 3,000 g/eg.

16. The composition of claim 12 wherein the polymer or copolymer has a molecular weight in the range of about 1000 to about 500,000.

17. The composition of claim 12 wherein the polymer or copolymer has a glass transition temperature (Tg) or heat distortion temperature (HDT) higher than 0° C.

18. The composition of claim 12 which has a minimum dusting temperature higher than 40° C.

19. The composition of claim 12 wherein the polymer or copolymer has a melt flow temperature lower than 180° C.

20. The composition of claim 12 wherein the thermal crosslinker is polyaziridine, polycarbodiimide, polyepoxide or a combination thereof.

21. The composition of claim 20 wherein the thermal crosslinker is the combination of a polyaziridine and a polyepoxide.

22. The composition of claim 12 wherein the molar ratio between the thermal crosslinker and the acid or acid anhydride functionality is in the range of about 0.8 to about 1.2.

23. The composition of claim 12 further comprising a photoinitiator or photosensitizer.

24. The composition of claim 12 which is dispersed or dissolved in a solvent selected from the group consisting of ketones, esters, ethers, glycol ethers, glycolether esters and pyrrolidones.

25. The composition of claim 12 wherein said polymer or copolymer may be expressed as follows: 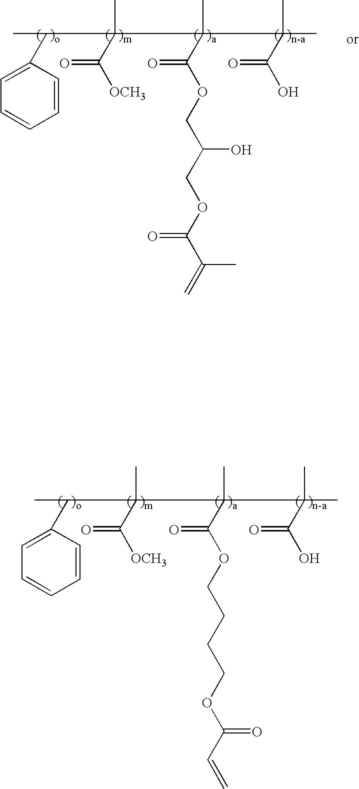
wherein o, m, a, n-a are the weight ratio of each repeating units;
o+m+n=1;
o is in the range of 10%-80%;
m is in the range of 5%-50%;
a is in the range of 5%-50%; and
n is in the range of 5%-80%.

26. A plastic article having a durable layer formed from a composition comprising
(a) a polymer or copolymer comprising at least one carboxylic acid or acid anhydride functionality for thermal crosslinking and at least one UV crosslinkable functionality; and
(b) a thermal crosslinker.

27. The article of claim 26 which is a plastic cover of a cell phone, pager, personal accessory, toy or educational device, plastic cover of a personal digital assistant or e-book, credit or smart card, identification or business card, face of an album, watch, clock, radio or camera, dashboard in an automobile, household item, laptop computer housing and carrying case, front control panel of a consumer electronic equipment, thermal transfer protective coating of identification, passport, inkjet printed or thermal printed image.

28. The article of claim 26 wherein a decorative layer is underneath the durable layer.

29. The article of claim 28 wherein said decorative layer is a metallic layer or an ink layer.
